(19) United States
(12) Patent Application Publication
(10) Pub. No.: US 2007/0131770 A1
(43) Pub. Date: Jun. 14, 2007

(54) Selectable focus direct part mark reader

(76) Inventor: Laurens Nunnink, Simpelveld (NL)

Correspondence Address: COGNEX CORPORATION;INTELLECTUAL PROPERTY DEPARTMENT, 1 VISION DRIVE, NATICK, MA, 01760-2077, US

(21) Appl. No.: 11/304,409

(22) Filed: Dec. 13, 2005

(51) Int. Cl. G06K 7/10

(52) U.S. Cl. 235/454; 235/462.41

(57) ABSTRACT

The present invention provides a direct part mark symbol reader that employs the use of high angle bright field illumination and low angle dark field illumination to create a digital image of the symbol that can be subsequently decoded. The reader employs an optical subsystem that produces a sharply focused image at either of the reading positions associated with the dark field illumination and the bright field illumination.

### BACKGROUND OF THE INVENTION

1. Field of the Invention

This invention relates to machine vision systems and symbology reader that employ machine vision and more particularly to the image formation system for the same.

2. Description of the Related Art

Machine vision systems use image acquisition devices that include camera sensors to deliver information on a viewed subject. The system then interprets this information according to a variety of algorithms to perform a programmed decision making and/or identification function. For an image to be most effectively acquired by a sensor in the visible, and near-visible light range, the subject should be properly illuminated.

In the example of symbology reading (also commonly termed “barcode” scanning) using an image sensor, proper illumination is highly desirable. Symbology reading entails the aiming of an image acquisition sensor (CMOS camera, CCD, etc.) at a location on an object that contains a symbol (a “barcode”), and acquiring an image of that symbol. The symbol contains a set of predetermined patterns that represent an ordered group of characters or shapes from which an attached data processor (for example a microcomputer) can derive useful information about the object (e.g. its serial number, type, model, price, etc.). Symbols/barcodes are available in a variety of shapes and sizes. Two of the most commonly employed symbol types used in marking and identifying objects are the so-called one-dimensional barcode, consisting of a line of vertical stripes of varying width and spacing, and the so-called two-dimensional barcode consisting of a two-dimensional array of dots or rectangles.

By way of background FIG. 1 shows an exemplary direct part mark reader 100 adapted for handheld operation. An exemplary handheld scanning appliance or handpiece 102 is provided. It includes a grip section 104 and a body section 106. An image formation system 151, shown in phantom, can be controlled and can direct image data to an on-board embedded processor 109. This processor can include a scanning software application 113 by which lighting is controlled, images are acquired and image data is interpreted into usable information (for example, alphanumeric strings derived from the symbols (such as the depicted two-dimensional barcode image 195). The decoded information can be directed via a cable 111 to a PC or other data storage device 112 having (for example) a display 114, keyboard 116 and mouse 118, where it can be stored and further manipulated using an appropriate application 121. Alternatively, the cable 111 can be directly connected to an interface in the scanning appliance and an appropriate interface in the computer 112. In this case the computer-based application 121 performs various image interpretation/decoding and lighting control functions as needed. The precise arrangement of the handheld scanning appliance with respect to an embedded processor, computer or other processor is highly variable. For example, a wireless interconnect can be provided in which no cable 111 is present. Likewise, the depicted microcomputer can be substituted with another processing device, including an onboard processor or a miniaturized processing unit such as a personal digital assistant or other small-scale computing device.

The scanning application 113 can be adapted to respond to inputs from the scanning appliance 102. For example, when the operator toggles a trigger 122 on the hand held scanning appliance 102, an internal camera image sensor (300, shown and described further below) acquires an image of a region of interest 131 on an object 105. The exemplary region of interest includes a two-dimensional symbol 195 that can be used to identify the object 105. Identification and other processing functions are carried out by the scanning application 113, based upon image data transmitted from the hand held. scanning appliance 102 to the processor 109. A visual indicator 141 can be illuminated by signals from the processor 109 to indicate a successful read and decode of the symbol 195.

In reading symbology or other subjects of interest, the type of illumination employed is of concern. Where symbology and/or other viewed subjects are printed on a flat surface with contrasting ink or paint, a diffuse, high-angle “bright field” illumination may best highlight these features for the sensor. By high-angle it is meant, generally, light that strikes the subject nearly perpendicularly (normal) or at an angle that is typically no less than about 45 degrees from perpendicular (normal) to the surface of the item being scanned. Such illumination is subject to substantial reflection back toward the sensor. By way of example, barcodes and other subjects requiring mainly bright field illumination may be present on a printed label adhered to an item or container, or on a printed field in a relatively smooth area of item or container.

Conversely, where a symbology or other subject is formed on a more-irregular surface, or is created by etching or peening a pattern directly on the surface, the use of highly reflective bright field illumination may be inappropriate. A peened/etched surface has two-dimensional properties that tend to scatter bright field illumination, thereby obscuring the acquired image. Where a viewed subject has such decidedly two-dimensional surface texture, it is best illuminated with dark field illumination. This is an illumination with a characteristic low angle (approximately 45 degrees or less, for example) with respect to the surface of the subject (i.e. an angle of more than approximately 45 degrees with respect to normal). Using such low-angle, dark field illumination, two-dimensional surface texture is contrasted more effectively (with indents appearing as bright spots and the surroundings as shadow) for better image acquisition.

In other instances of applied symbology a diffuse direct illumination may be preferred. Such illumination is typically produced using a direct-projected light source (e.g. light emitting diodes (LEDs)) that passes through a diffuser to generate the desired illumination effect.

To take full advantage of the versatility of a camera image sensor, it is desirable to provide bright field, dark field and diffuse illumination. However, dark field illumination must be presented close to a subject to attain the low incidence angle thereto. Conversely, bright field illumination is better produced at a relative distance to ensure full area illumination.

Commonly assigned U.S. patent application Ser. No. 11/014,478, entitled HAND HELD SYMBOLOGY READER ILLUMINATION DIFFUSER and U.S. patent application Ser. No. 11/019,763, entitled LOW PROFILE ILLUMINATION FOR DIRECT PART MARK READERS, both by Laurens W. Nunnink, the teachings of which are expressly incorporated herein by reference, provide techniques for improving the transmission of bright field (high angle) and dark field (low angle) illumination. These techniques include the provision of particular geometric arrangements of direct, bright field LEDs and conical and/or flat diffusers that are placed between bright field illuminators and the subject to better spread the bright field light. The above-incorporated HAND HELD SYMBOLOGY READER ILLUMINATION DIFFUSER further teaches the use of particular colors for improving the illumination applicable to certain types of surfaces. However, it has been observed that the choice of bright field, dark field, direct or diffuse light is not intuitive to user for many types of surfaces and/or the particular angles at which the reader is directed toward them. In other words, a surface may appear to be best read using dark field illumination, but in practice, bright field is preferred for picking out needed details, especially at a certain viewing angle. Likewise, with handheld readers, the viewing angle is never quite the same from surface to surface (part-to-part) and some viewing angles be better served by bright field while other may be better served by dark field.

When attempting to read and decode various types of parts or components, it may be desirable to try diffuse or bright field illumination with the part held at a distance from the reader, or to try low angle dark field illumination with the part close to the reader. This sequential attempt may result in unacceptable read performance by the user, and configuration of a reader to perform such a sequential read attempt is cumbersome, if not difficult. Currently, for a reader to be considered efficient, the reading process should take place within 200 milliseconds or less. Stepping through illumination types, storing results, comparing and deriving the best image may exceed desired time limits. It is, therefore highly desirable to provide a technique that allows the best form of illumination to be employed at once for all types of surfaces and scan angles, and for acquired images from this illumination to be used immediately to derive meaningful image data.

### BRIEF SUMMARY OF THE INVENTION

This invention overcomes the disadvantages of the prior art by providing an improved system and method for reading and decoding symbols marked on the surface of an object. In an illustrative embodiment, a reader having the ability to project both bright field and dark field illumination, has an image formation system that uses a bimodal optical subsystem that provides the ability to sharply focus an image of the object at either of the bright field reading position or the dark field reading position.

In an embodiment of the invention, the bimodal optical subsystem uses an electrically actuated liquid lens to provide the two focal lengths necessary to obtain sharply focused images at both the bright field reading position and the dark field reading position. In another embodiment, the bimodal optical subsystem uses an insertable lens to provide the two focal lengths of the subsystem.

In another embodiment of the invention, the bimodal optical subsystem uses a plurality of mirrors to maintain the same focal length of the optical subsystem at the bright field reading position and the dark field reading position. At least one of the plurality of mirrors rotates into a first position for one reading position, and into a second position for the other reading position.

In yet another embodiment of the invention, the bimodal optical subsystem uses a dichroic filter adapted to selectively reflect or transmit reflected illumination into one of two optical paths that have the same effective length, thereby enabling the formation of sharply focused images at two effective operating distances. The selective reflection by the dichroic filter is performed by providing at distinct wavelength of illumination for each of the bright field and dark field modes of illumination.

An object of the invention is to automatically determine the reading position of the reader, and to activate the appropriate illumination (i.e., bright field or dark field illumination), and the mode of the bimodal optical subsystem, so that the user does not need to change the configuration of the reader or manually switch reading modes during run time.

In an embodiment of the invention, an infra-red sensor detects the range at which the object is positioned relative to the reader. If the object is in the bright field reading position, the bright field illumination is activated, and the mode of the bimodal optical subsystem is set to the bright field reading mode. Conversely, if the object is in the dark field reading position, the dark field illumination is activated, and the mode of the bimodal optical subsystem is set to the dark field reading mode.

In another embodiment, a pair of aiming beams can be projected onto the part, and an analysis of the appearance of the aiming beams is performed to determine the reading position. The appropriate illumination, and the associated mode of the bimodal optical subsystem is then automatically set by the reader to acquire an image and decode the symbol.

In yet another embodiment of the invention, a color sensor is used to detect the color of the reflected illumination. In this embodiment, the dark field illumination is one color, and the bright field illumination is another color. When the reader is in the bright field reading mode, the color sensor can detect that bright field illumination is the predominate reflected illumination, and thus, the reader is set to the bright field reading mode. If only the dark field illumination color is detected, the reader is set to the dark field reading mode.

### BRIEF DESCRIPTION THE SEVERAL VIEWS OF THE DRAWING

The present invention is further described in the detailed description which follows, by reference to the noted drawings by way of non-limiting exemplary embodiments, in which like reference numerals represent similar parts throughout the several views of the drawings, and wherein:

FIG. 1, already described, is a perspective view of a handheld direct part mark reader with integrated illumination according to the background art;

FIG. 2 is a schematic view of an embodiment of the present invention in both of the bright field reading positions and the dark field reading positions;

FIG. 3 is a schematic view of the optical components of the present invention;

FIG. 4 depicts an adjustable focus lens according to a first illustrative embodiment of the present invention;

FIG. 5 is a schematic view of a second alternative embodiment of the present invention in the dark field reading position;

FIG. 6 is a schematic view of the embodiment of the present invention according to FIG. 5, in the bright field reading position;

FIG. 7 is a schematic view of a third embodiment of the present invention that uses a dichroic filter with internally reflecting mirrors to maintain the focal length of the bimodal optical subsystem in each of a dark field and a bright field reading position;

FIG. 8 is a schematic view of a fourth embodiment of the present invention that uses a prism to maintain the focal length of the bimodal optical subsystem in each of a dark field and a bright field reading position;

FIG. 9 is a schematic view of a fifth alternative embodiment of the present invention in the dark field reading position;

FIG. 10 is a schematic view of the embodiment of the present invention according to FIG. 9, in the bright field reading position;

FIG. 11 is a front view of a handheld reader incorporating an embodiment of the present invention;

FIG. 12 is a schematic view of the present invention depicting a method for determining the reading position of the direct part mark reader of the present invention during operation; and

FIG. 13 is a schematic view of the present invention depicting an alternative method for determining the reading position of the direct part mark reader of the present invention during operation.

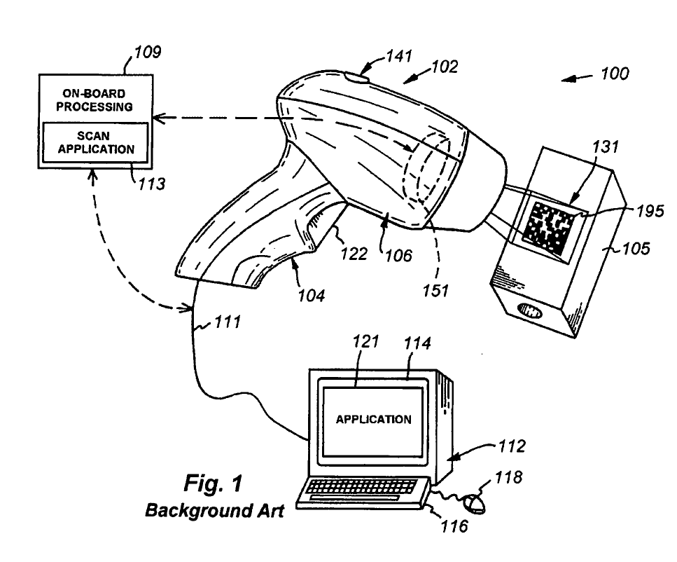

### DETAILED DESCRIPTION OF THE INVENTION

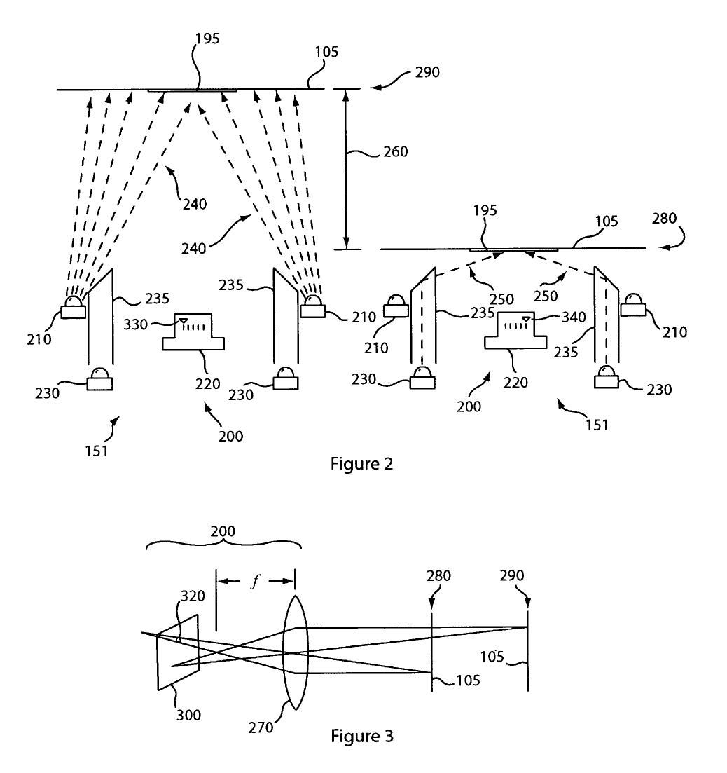

FIG. 2 depicts a cross sectional view of the image formation system 151 of a direct part mark reader according to the present invention. When configured to read a symbol 195 using bright field illumination, the bright field illuminators 210 project high-angle bright field illumination 240 at the object 105 in the bright field reading position 290. The reflected illumination captured by the imager 220 having a first focus setting 330 is passed to the on-board processor 109 (not shown) for decoding. When configured to read a symbol 195 using dark field illumination, the dark field illuminators 230 project illumination into a light pipe 235 that directs low angle dark field illumination 250 on the object 105 in the dark field reading position 280. The reflected illumination captured by the imager 220 having a second focus setting 340 is passed to the on- board processor 109 (not shown) for decoding. The relative position 260 of the object 105 is shown where the object is positioned further from the reader when using bright field illumination, and closer to the reader when using dark field illumination. Typical direct part mark readers according to the prior art will utilize a fixed-focus optics in the imager 220 that is either optimized for the relative position of bright field illumination or the relative position of dark field illumination, or a position between the two.

A bimodal optical subsystem 200 provides the image formation system 151 with the ability to obtain a sharply focused image at either of the dark field reading positions 280 or the bright field reading positions 290. As shown in FIG. 2, the bimodal optical subsystem 200 is provided through a first focus setting 330 and a second focus setting 340, where each of the focus settings is associated with a mode of the bimodal optical subsystem 200.

The imager 220 shown in FIG. 2 includes an adjustable focus lens 270, shown schematically in FIG. 3. The lens 270 at the first focus setting 330 has a focal length f and projects reflected illumination onto the image sensor 300 from the object 105 when it is in the bright field position 290, and from the object 105 when it is in the dark field position 280. The image sensor 300 can be a CMOS or CCD device as is commonly used in the art. As shown in FIG. 3, a sharp image of the object 105 can be formed on the sensor 300 according to the thin lens equation where p is the distance from the lens 270 to the object 105, and v is the distance from the lens 270 to the sensor 300:
(1/p)+(1/υ)=(1/f)

As shown in FIG. 3, when the object 105 is in the bright field reading position 290 with the focal length at the first focus setting 330, a sharp image of the object is projected on the imager 300. When the object is in the dark field reading position 280 using the same focal length f set to the first focus setting 330, a circle of confusion 320 forms on the sensor 300, which results in an out-of-focus image. The size of the circle of confusion 320 is minimized by changing the focal length f to the second focus setting 340. The bimodal optical subsystem 200 of the present invention provides the capability for producing a sharply focused image at either of the dark field reading position 280 or the bright field reading position 290.

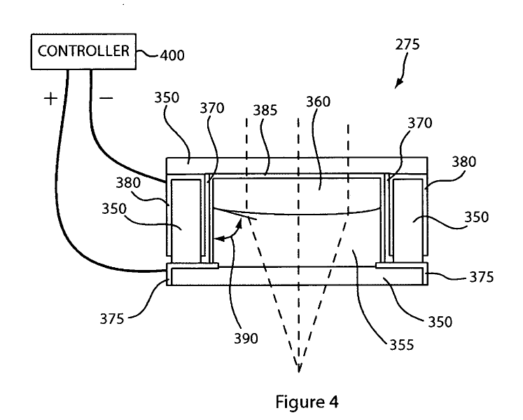

FIG. 4 depicts a cross-section of a first illustrative embodiment of the bimodal optical subsystem 200 according to the present invention. An electrically actuated liquid lens 275 is shown, such as the FluidFocus lenses available from Philips Corporation or electrowetting autofocus lenses from Varioptic, Lyon, France. The lens 275 is constructed in a glass housing 350 that contains two immiscible fluids: a conducting fluid 355 (water); and an insulating fluid 360 (oil). Electrodes 375 charge the conducting fluid 355 with reference to the ground plane electrode 380, that is isolated from the conducting fluid by an insulator 370 and a hydrophobic coating 385. The focal length of the lens 275 can be changed by applying a particular voltage to the electrode 375, that changes the shape of the interface between the conductive fluid 355 and the insulating fluid 360, defined as the meniscus angle 390. During operation, the on-board processor 109 (not shown) provides a signal to a focus controller 400, that applies the appropriate voltage to the electrode 375 and ground electrode 380 to provide a selectively focused image in both of a bright field position and a dark field position.

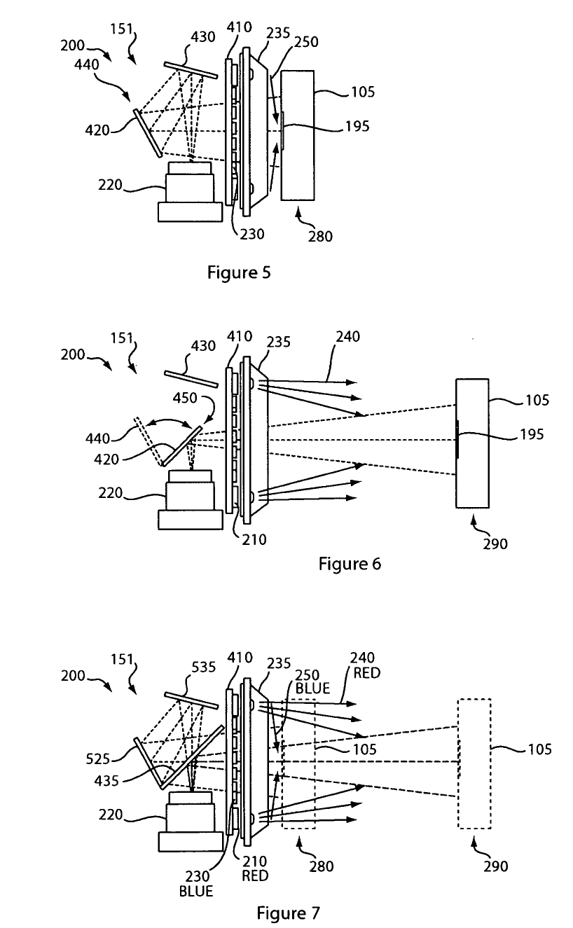

FIGS. 5 and 6 show a second illustrative embodiment of the present invention that provides a selectively focused image in both of a dark field position (FIG. 5) and a bright field position (FIG. 6). As shown in FIG. 5, when the object 105 having a symbol 195 is positioned in the dark field reading position 280, dark field illumination 250 can be projected onto the object at a low angle from dark field illuminators 230 of an illumination module 410 and the light pipe 235. Reflected illumination from the object 105 is enters the image formation system 151, and directed into the imager 220 by a pivoting mirror 420 in a first position 440, and fixed mirror 430. The bimodal optical subsystem 200 is provided in this embodiment through the actuation of the pivoting mirror 420 so that the length of the optical path is the same for both the bright field reading position 290 and the dark field reading position 280. Thus, by actuation of the pivoting mirror 420, a sharply focused image can be obtained at each reading position.

As shown in FIG. 6, when the object 105 having a symbol 195 is positioned in the bright field reading position 290, bright field illumination 240 is projected onto the object 105 from bright field illuminators 210. Reflected illumination is enters the image formation system 151 with the pivoting mirror 420 in a second position 450 (the first position 440 shown in phantom), to direct the reflected illumination directly into the imager 220. The position of the pivoting mirror 420 can be controlled by the focus controller 400 (not shown) by actuating a solenoid or electric motor actuator coupled to the pivoting mirror 420.

FIG. 7 shows a third illustrative embodiment of the present invention that provides a selectively focused image in both of a dark field position and a bright field position. As shown in FIG. 7, an optical path is provided for reflected illumination from both the dark field reading position 280 and the bright field reading position 290. A dichroic color filter 435 is positioned to reflect certain light wavelengths into the imager 220, while transmitting other light wavelengths. Reflective dichroic filters are used at a 45° angle of incidence and will reflect a specific color of illumination while transmitting the remaining visible spectrum.

In this embodiment, the dark field illuminators 230 on the illumination module 410 emit a blue colored light, and the bright field illuminators 210 on the illumination module 410 emit a red colored light. Dark field illumination 250 emanating from the light pipe 235 will be blue, while bright field illumination 240 will be red. The dichroic filter 435 is selected to reflect red light while transmitting other wavelengths of the visible spectrum, including blue. A dichroic filter of this type can be obtained from Edmund Optics, Inc., Barrington, N.J., part number NT47-266.

Bright field illumination reflecting from the object 105 in the bright field reading position (shown in phantom) will be red, and thus directly reflected from the dichroic filter 435 into the imager 220. Dark field illumination reflecting from the object 105 in the dark field reading position (shown in phantom) will be blue, and thus transmitted directly through the dichroic filter 435, and reflected by a first mirror 525 and a second mirror 535, then transmitted through the dichroic filter 435 into the imager 220. One skilled in the art will appreciate that the image sensor 300 (not shown) in the imager 220 can be a color sensor or a monochrome sensor. In this embodiment, the bimodal optical subsystem 200 maintains the same effective length of the optical path of the dark field illumination and the bright field illumination, and therefore a fixed focal setting of the image formation system 151 can provide a clearly focused image of the object at the bright field reading position 290 and the dark field reading position 280 without any moving parts.

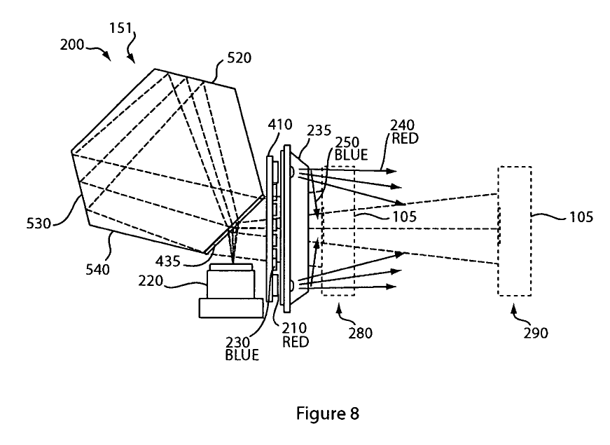

FIG. 8 shows a fourth illustrative embodiment of the present invention that provides a selectively focused image in both of a dark field position and a bright field position. As shown in FIG. 8, an optical path is provided for reflected illumination from both the dark field reading position 280 and the bright field reading position 290. Bright field illumination reflecting from the object 105 in the bright field reading position 280 (shown in phantom) is directly reflected from the prism 540 into the imager 220. Dark field illumination reflecting from the object 105 in the dark field reading position 290 (shown in phantom) is transmitted into the prism 540 and internally reflected on a first reflective surface 530 and a second reflective surface 520, and then directed into the imager 220. One skilled in the art will appreciate that variations in the design of the prism 540 can be employed to provide a selectively focused image at two reading positions.

The dark field illumination 250 can be a different color as the bright field illumination 240, as shown in the FIG. 8 as blue and red illumination emanating from blue dark field illuminators 230 and red bright field illuminators 210, respectively. A color sensor in the imager 220 can be used to selectively acquire an image of light reflected from either of the two reading positions. A dichroic filter 435 can be used to direct a certain color of illumination into the prism, or reflected directly into the imager 220, as described above in reference to the embodiment of FIG. 7. In this embodiment, the bimodal optical subsystem 200 maintains the same effective length of the optical path of the dark field illumination and the bright field illumination, and therefore a fixed focal setting of the image formation system 151 can provide a clearly focused image of the object at the bright field reading position 290 and the dark field reading position 280 without any moving parts.

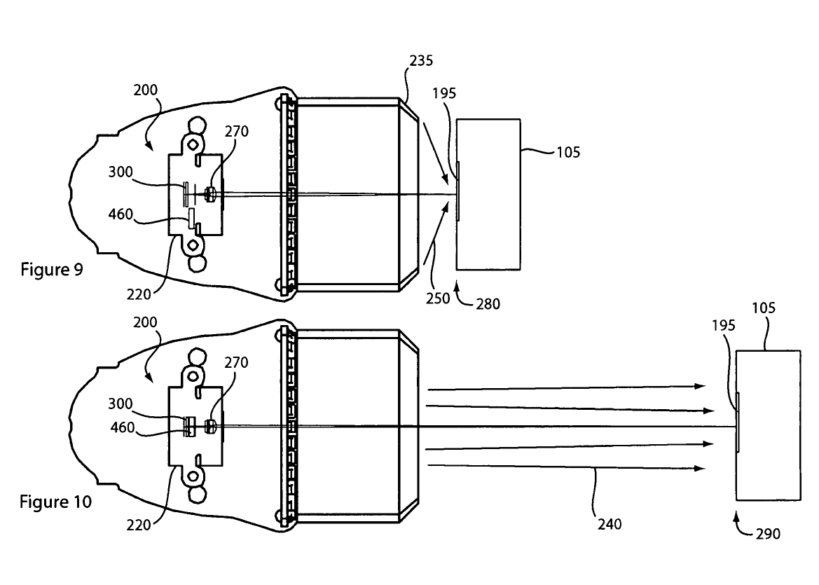

FIGS. 9 and 10 depict a fifth illustrative embodiment of the present invention that provides a selectively focused image in both of a dark field position (FIG. 9) and a bright field position (FIG. 10). As shown in FIG. 9, dark field illumination 250 is projected from the light pipe 235 at the symbol 195 on the object 105 in the dark field reading position 280. Reflected illumination enters the imager 220 to form a focused image on the image sensor 300.

As shown in FIG. 10, when the object 105 having a symbol 195 is in the bright field reading position 290, bright field illumination 240 is projected onto the object 105. Reflected illumination from the object 105 enters the imager 220 through an insertable lens 460 to form a focused image on the image sensor 300. The insertable lens 460 introduces a refraction of the reflected illumination that changes the focal distance so that the image of the object 105 in the bright field reading position 290 is sharply focused. The bimodal optical subsystem 200 is provided in this embodiment through the selective insertion of the insertable lens 460. In an exemplary embodiment of the present invention, the insertable lens 460 is a flat glass plate 1.3 mm thick that is positioned 0.2 mm from the protective window of the image sensor 300. The selectively focused image of both a dark field position and a bright field position in this embodiment is determined by the thickness and refractive index of the flat glass plate insertable lens 460, and does not require precise positioning of the glass plate, as long as it is inserted in the optical path in between the imager 220 and the lens 270. The insertable lens 460 can be selectively inserted or retracted from the optical path, as controlled by the focus controller 400 (not shown) by actuating a solenoid or electric motor coupled to the insertable lens 460.

When operating a direct part mark reader according to the present invention, the reader 100 can be configured to operate in either of a bright field reading mode, or a dark field reading mode, by configuring the illumination to provide either of a bright field illumination or a dark field illumination respectively. The selectable focus capability of the present invention can also be configured for the intended reading mode (i.e., the selectable focus can be adapted for the dark field reading position 280, or the bright field reading position 290 in conjunction with the associated illumination).

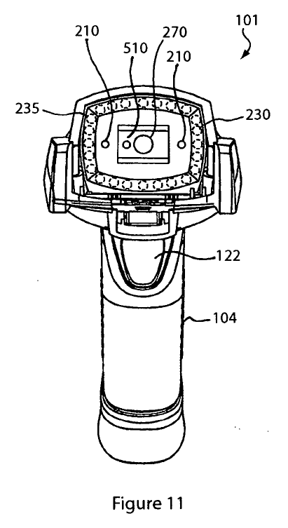

Referring to FIGS. 11, 12 and 13, there are provided methods that can be used to automatically configure the illumination and the selectable focus setting of the present invention to that of a bright field reading mode or a dark field reading mode, depending on the relative position of the direct part mark reader 100 when the system is actuated. A range sensing process is employed to determine if the object is one of the dark field reading position 280 or the bright field reading position.

As used herein, a process refers to a systematic set of actions directed to some purpose, carried out by a ny suitable apparatus, including but not limited to a mechanism, device, component, software, or firmware, or any combination thereof that work together in one location or a variety of locations to carry out the intended actions. In an illustrative embodiment, the range sensing process can be performed using the on-board processor 109 as a programmed routine in the scan application 113.

FIG. 11 shows a configuration of the direct part mark reader 100 according to the present invention that can automatically determine the mode of illumination and the associated selectable focus setting. The reader 100 has bright field illuminators 210 to provide high angle bright field illumination, and dark field illuminators 230 in cooperation with a light pipe 235 to provide low angle dark field illumination. Reflected illumination directed into the bimodal optical subsystem 200 and the imager with a selectable focus setting according to a dark field reading position or a bright field reading position, as described above. In the embodiment according to FIG. 11, an infra-red (IR) sensor 510 provides range sensing information to the focus controller 400 (not shown). If the IR sensor 510 detects that the object 105 is at the dark field reading position 280, then the dark field illuminators 230 are activated, and the mode of the bimodal optical subsystem 200 for dark field is selected, when the trigger 122 is actuated. Conversely, if the IR sensor 510 does not detect that the object 105 is in the dark field reading position, then the bright field illuminator 210 are activated, and the mode of the bimodal optical subsystem 200 for bright field is selected, when the trigger 122 is actuated. One skilled in the art will appreciate that alternative sensors are available to perform the range finding function of the IR sensor 510, including, for example, ultrasonic range sensors.

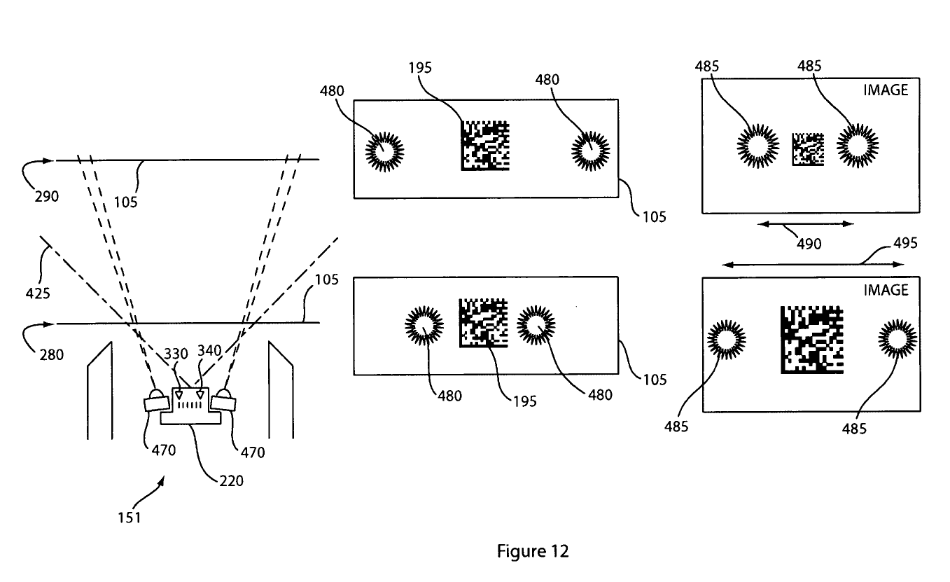

FIG. 12 shows a configuration of the direct part mark reader 100 according to the present invention that can automatically determine the mode of illumination and the associated mode of the bimodal optical subsystem 200. A pair of aiming illuminators 470 are mounted in the image formation system 151 to project an aiming illumination pattern 480 on the object 105 that appear as bright spots 485 in the image. Because of the opening angle 425 of the imager 220, the field of view will increase at larger distances. Accordingly, the position of the spots 485 in the image will change when the object 105 is at different positions, even if the aiming beams are parallel to the optical axis. When the object 105 with the symbol 195 is in the dark field reading position 280, the aiming illumination pattern 480 that appears in the image of the object 105 is different than the appearance of the aiming pattern 480 in the image of the object 105 in the bright field reading position 290. As shown in FIG. 12, when the object 105 is in the dark field reading position 280, the bright spots 485 from the pair of aiming illuminators 470 is separated by a first distance 495. When the object 105 is in the bright field reading position 290, the bright spots 485 from the pair of aiming illuminators 470 that appears on the object 105 is separated by a second distance 490.

During operation, either when the a read event is initiated, for example, by activation of the trigger 122, or continuously during idle periods, a pattern recognition process is performed on an acquired image to detect a pair of aiming patterns 480, and to measure the distance of separation. If the separation distance between the aiming pattern 480 is determined to be approximately equal to the separation at the dark field reading position 495, then the bimodal optical subsystem 200 is set to the dark field mode and the illumination for the direct part mark reader 100 is configured for reading dark field. Otherwise, the bright field reading mode is selected and the illumination mode is set for reading bright field.

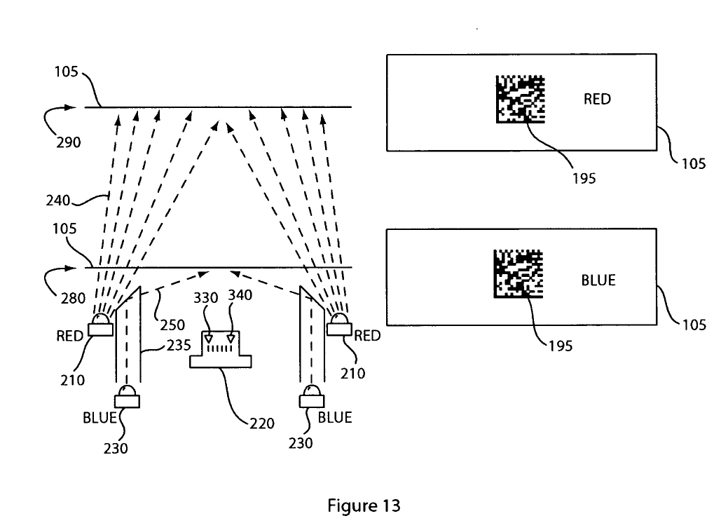

FIG. 13 shows an alternate configuration of the direct part mark reader 100 according to the present invention. The selection of the first or second focus setting is determined by the detection of the color of illumination projected onto the object 105 when both the bright field illumination and the dark field illumination is simultaneously projected. As shown in FIG. 13, the dark field illuminators 230 emit a blue color, and the bright field illuminators emit a red color. If the object 105 is in the bright field reading position 290, the bright field illumination 240 will be the predominate illumination, and the object 105 and features of the symbol 195 will appear red. If the object 105 is in the dark field reading position 280, the dark field illumination 250 will be the predominate illumination (since the light pipe 235 will block the bright field illumination 240), and the object 105 and features of the symbol 195 will appear blue. According to this embodiment, the imager 220 must use a color sensor, and the focus controller will be responsive to an analysis of an acquired image to determine the dominant color. For example, a color histogram can be performed to identify the color in an image that is associated with the peak of the histogram. The focus is controller 400 (not shown), responsive to the results of the image analysis will select the first focus position 330 if the detected color is red, or the second focus position 340 if the detected color is blue. A run-time image is then acquired using the appropriate mode of the bimodal optical subsystem 200.

While the invention has been described with reference to the certain illustrated embodiments, the words that have been used herein are words of description, rather than words of limitation. Changes may be made, within the purview of the appended claims, without departing from the scope and spirit of the invention in its aspects. Although the invention has been described herein with reference to particular structures, acts, and materials, the invention is not to be limited to the particulars disclosed, but rather extends to all equivalent structures, acts, and materials, such are within the scope of the appended claims.

I claim:

1. A direct part mark reader of the type used to decode a symbol marked on the surface of an object comprising:
a bright field illumination source adapted to provide high angle illumination of the object in a bright field reading position at a first distance from the reader;
a dark field illumination source adapted to provide low angle illumination of the object in a dark field reading position at a second distance to the reader;
an image sensor that captures an image of the object from reflection of at least one of the bright field illumination and the dark field illumination; and
a bimodal optical subsystem, cooperative with the image sensor, adapted to provide a sharply focused image of the object in each of the bright field reading positions and the dark field reading positions.

2. The reader as recited in claim 1 in which the bimodal optical subsystem comprises a liquid lens wherein the liquid lens is electrically actuated in a first focus setting for the bright field reading position and in a second focus setting for the dark field reading position.

3. The reader as recited in claim 1 in which the bimodal optical subsystem comprises an insertable lens that is selectively positioned in the path of the reflection of the bright field illumination, and selectively positioned not in the path of the reflection of the dark field illumination.

4. The reader as recited in claim 3 in which the insertable lens is a flat glass plate.

5. The reader as recited in claim 1 in which the bimodal optical subsystem further comprises a plurality of mirrors, one of the plurality of mirrors selectively positioned to direct the reflection of the bright field illumination in a first optical path to the image sensor, and selectively positioned to direct the reflection of the dark field illumination in a second optical path to the image sensor.

6. The reader as recited in claim 5 in which at least one of the plurality of mirrors is fixedly positioned in one of the first optical path and the second optical path to direct illumination to the image sensor.

7. The reader as recited in claim 1 wherein the bright field illumination source emits illumination having a first color, and the dark field illumination source emits illumination having a second color; and in which the bimodal optical subsystem further comprises;
a dichroic filter selected to reflect at least one of the first color and the second color in a first optical path to the image sensor, and transmit any other color therethrough; and
a plurality of mirrors cooperatively positioned to direct illumination transmitted through the dichroic filter in a second optical path to the image sensor;

8. The reader as recited in claim 1 wherein the bimodal optical subsystem further comprises a prism.

9. The reader as recited in claim 8 wherein the bright field illumination source emits illumination having a first color, and the dark field illumination source emits illumination having a second color; and in which the prism further comprises;
a dichroic filter selected to reflect at least one of the first color and the second color in a first optical path to the image sensor, and transmit any other color therethrough; and

10. A direct part mark reader of the type used to decode a symbol marked on the surface of an object comprising:
a bright field illumination source adapted to provide high angle illumination of the object in a bright field reading position at a first distance from the reader;
a dark field illumination source adapted to provide low angle illumination of the object in a dark field reading position at a second distance to the reader;
an image sensor that captures an image of the object from reflection of at least one of the bright field illumination and the dark field illumination;
a range sensing process that
determines if the object is in one of the bright field reading position and the dark field reading position; and
activates one of the bright field illumination and the dark field illumination in response to the determined object position; and
a bimodal optical subsystem, cooperative with the image sensor, adapted to provide a sharply focused image of the object in each of the bright field reading positions and the dark field reading positions responsive to the range sensing process.

11. The reader as recited in claim 10 in which the range sensing process comprises an infra-red sensor to determine the position of the object.

12. The reader as recited in claim 10 further comprising a plurality of aiming illuminators that produce an aiming beam pattern on the object that exhibits features that vary in proportion to the relative distance between the reader and the object; and wherein the range sensing process uses the aiming beam pattern to determine if the object is in one of the bright field reading position and the dark field reading position.

13. The reader as recited in claim 10 wherein;
the image sensor is a color sensor;
the bright field illumination is a first color;
the dark field illumination is a second color, the first color and the second color being different; and
the range sensing process uses the color sensor to determine if the object is in one of the bright field reading position and the dark field reading position by an analysis of reflected illumination.
